(19) United States
(12) Patent Application Publication
(10) Pub. No.: US 2007/0219845 A1
(43) Pub. Date: Sep. 20, 2007

(54) MicroFranchise

(75) Inventor: David G. Crane, Fremont, CA (US)

Correspondence Address: David Crane;You've Got It Maid, 39270 Paseo Padre Suite 331, Fremont, CA, 94538, US

(73) Assignee: David G. Crane, Fremont, CA (US)

(21) Appl. No.: 11/308,302

(22) Filed: Mar. 15, 2006

(51) Int. Cl. G06Q 10/00; G07G 1/00; G06Q 30/00; G06F 17/30

(52) U.S. Cl. 705/10; 705/1

(57) ABSTRACT

MicroFranchise—Process/System for individuals in direct or personal service industries to have personal ownership of their work with widely recognizable branding and systems, increasing quality of service to the customer and building personal wealth.

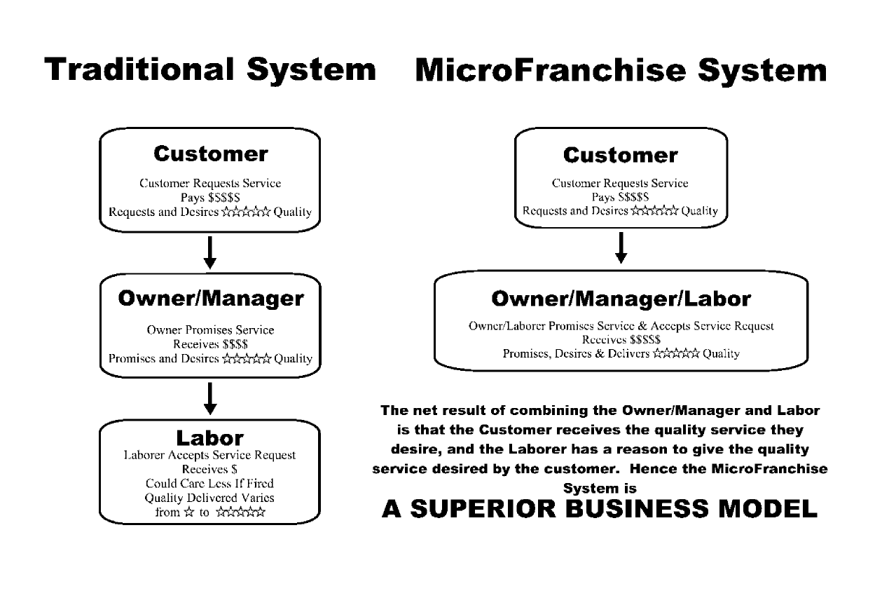

### FIELD OF THE INVENTION

The direct and personal service industry is any service industry wherein the consumer receives the overwhelming majority of the services received from an individual or a small group of people (typically no more that 4 (four) people) such as housecleaners, caterers, massage therapists, tax advisors, landscapers, etc.))

### BACKGROUND

The direct and personal service industry (DPSI) has been plagued with several issues that have held it back from greater efficiencies and customer and worker satisfaction. One of two things typically happens in the DPSI.

The first is that a potential customer (please refer to the left side of the drawing) calls a recognized company (corporate structure or franchise) to provide a service for them. The owner or manager (or sales person in some cases) promises to provide a certain level (a high level) of service to the customer for a price. The company sends out an employee or independent contractor (we'll call this person the laborer) to perform the service, giving him/her a small percentage of the revenue generated and keeping the rest to pay for expenses, management salaries and profits. Frequently, the laborer could work as hard as he/she could in that job for the rest of his/her life and never earn more than enough to pay for their basic expenses. The laborer usually is paid so little, that they don't care enough about the client to provide the level of service promised. This lack of commitment and quality is a constant source of grief, struggle and disappointment for the client and the owner/manager and the lack of adequate compensation is a source of grief, struggle and disappointment for the laborer.

The second scenario is that the laborer wants to start their own business providing the labor him/herself but does not have a recognizable brand, system, and/or knowledge/experience to attract the needed market response and/or avoid the risks and pitfalls that cause 4 of every 5 businesses fail within the first couple years, respectively. Most who try, fail because the risks are too great.

If the laborer purchases a traditional franchise to try to reduce the risk of owning a business, he/she falls into the problems listed in the first scenario.

So, we can clearly see the problems of both scenarios, in one, there is a lack of incentive/motivation for the laborer to provide services as they are desired (whether employed by a corporation or a franchise owner) and in the other, failure is the typical result (the risk is too high).

### DETAILED DESCRIPTION OF THE INVENTION

The solution is a MicroFranchise. A MicroFranchise is similar to a franchise; however, it is not a system to get other people to work for you according to a preformed method and branding, but a process/system for the laborer to be the owner and manager of their own business with preformed methods and branding. The distinction at first may appear slight, however, the results are drastically different because key motivators are displaced from their traditional (ineffective) place and repositioned in a way that makes all the difference in the world to the laborer and client and thus also to the owner/manager (who, in a MicroFranchise, happens to be the laborer as well).

In a MicroFranchise, the laborer is the owner of the business franchise. They, the owner, cannot hire others to perform their principal labor/service for the client and must perform the service him/herself. The principal labor/service is the service that the client pays for and not such services that are incidental to running the MicroFranchise business (i.e. marketing, advertising, collections, call centers, equipment maintenance, repairs, etc., unless any of these items are the principal service for which the client is paying). In many instances, the MicroFranchisor may choose to provide some or all of these services as part of their system to support the MicroFranchisee.

There could potentially be more than one owner, but each owner would mandatorily be involved in the end delivery of service to the client as a laborer. There typically could not be more than a very small number (approximately 4 depending on the industry) of owners in this type of business as getting larger than a small group of individuals would require a management structure within the MicroFranchise and each of the partners in the MicroFranchise have ownership and management control of the company.

The drastic change of motivators (and therefore the genius of this new system) is that the laborer becomes enabled to earn a much greater percentage of the revenues generated from the service activities, if the laborer does something that causes the loss of the client, he/she loses that source of income and has to try to find a way to replace that income (whereas as an employee, if a client is lost, the company has to take the (financial) hit and the burden of trying to find a new client), and the more clients that the laborer has, the more his MicroFranchise business is worth (upon sale and in current revenue generation), all of which provide previously unattainable additional means of motivation to provide excellent service to the client.

As a result of the better quality, the client is more satisfied with the service, which increases the value of the service to the client and enables the MicroFranchise Owner to charge according to the value he/she provides (charge more) if he/she chooses (thus also increasing the value of the MicroFranchise process to the owner and increasing the value of the business).

The MicroFranchisor will also provide systems, branding, support and training typical of traditional franchises, but will be focused on the needs of the laborer, manager and owner and not just on the owner, thus providing the support necessary to reduce the risks and pitfalls that lead to the demise of the typical business. In some instances, the support offered by the MicroFranchisor will be greater than that of the traditional franchise in order to more fully allow the laborer to focus on their specialty, serving the client.

The MicroFranchise can be transferred to others for consideration (payment) and so, when the laborer is ready to retire, stop working the MicroFranchise, he/she has the option to sell it to another for market value.

Brief Description of Diagram

On the left is a flowchart of the typical business relationship in the direct services industry. On the right is a flowchart of the MicroFranchise business relationship.

Contained in each bubble are the following
The name of the entity
What they request, promise or accept
Transaction of monies paid or received
The level of quality desired, promised or delivered
   Similarities to Other Patents?

The question is, “is this the similar to other patents, and if so, what substantially differentiates this new invention?” The answer is, “yes, but it has many differences that are significant and important.” U.S. Pat. No. 6,351,738 is for a collaborative business system. The system as described does provide for economies of scale in purchasing and things of that sort, but it is designed so that each entity is independent and free to design their own business structure, branding and other systems such that they are “non-franchisor, for-profit hub business entit(ies and) a plurality of non-franchisee participants.” This means that any and all of the support given could be taken as a mere suggestion and not followed since they are “independently owned and operated relative to said hub business entity” and not bound by franchise (or MicroFranchise) agreements, which have traditionally been used to control the franchisee enough to ensure that the customer sees the same end result (product/service) and the proven success afforded by the franchise system is practically guaranteed (the value of franchising). This patented system is also different from what is currently being filed inasmuch as they define exclusive territories (which is not required by MicroFranchising), have an enormous emphasis on a hub-and-spoke formula (not part of MicroFranchising), and seem to be more of a loose association that collaboratively works together (rather than a much more uniform and cohesive group as prescribed by MicroFranchises). For further delineations of the differences of a MicroFranchise and the patent currently cited, please read their patent description under “background” under item “3” as the differences cited by the other patent owner in regards to franchises hold true to MicroFranchises.

What is claimed is:

1. A new business process and system to be used in direct and/or personal service industries that enables: Processes and systems, which change the current business structure to provide inherent and integrated motivators to substantially enhance and improve the quality and nature of the business relationship between the client and the provider of the service because, the provider of services gains greater financial opportunities through the new MicroFranchise system than typically available in an employment relationship through receiving higher proportions of the revenues, carrying the financial burden and reward of retaining clients or losing them and through building a business/clientele that can be sold for consideration (money, etc.).

2. The client will receive better quality service because the service provider has a greater motivation (in addition to the items stated in claim 1, MicroFranchise Owners will reap the fruits of the quality of their labor (i.e. good quality, more customers retained and if he/she provides poor quality, the clients will be lost—and thus their income) to ensure the clients satisfaction (the principle cause of poor quality service is that service providers previously didn't have sufficient incentive to provide consistently high quality work).

3. Sufficient support to reduce the risks of owning a business.
